(19) United States
(12) Patent Application Publication
(10) Pub. No.: US 2001/0017974 A1
(43) Pub. Date: Aug. 30, 2001

(54) Moving picture frame searching device, moving picture frame searching method, and record medium on which processing therefor is recorded

(75) Inventor: Akihiro Oue, Yokohama-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/790,608

(22) Filed: Feb. 23, 2001

(30) Foreign Application Priority Data
Feb. 25, 2000 (JP) 2000-49877

(51) Int. Cl. H04N 5/781; H04N 5/783

(52) U.S. Cl. 386/69; 386/70; 386/125

(57) ABSTRACT

A bit stream area RG0 stored in a hard disk unit 10 is divided into two bit stream subareas RG1 and RG2. Pictures in the neighborhood of the front positions of the bit stream sub areas RG1 and RG2 after the division are multiplexed and displayed on the monitor 28. A user confirms the display on the monitor 28 and selects one bit stream subarea which contains a moving picture frame which he or she tries to watch. Thus, the search for the moving picture frame which the user tries to watch can be facilitated.

### CROSS REFERENCE TO RELATED APPLICATION

This application claims benefit of priority under 35 U.S.C. §119 to Japanese Patent Application No. 2000-49877, filed on Feb. 25, 2000, the entire contents of which are incorporated by reference herein.

### BACKGROUND OF THE INVENTION

1. Field of the Invention

The present invention relates to a moving picture frame searching device, a moving picture frame searching method, and a record medium on which processing therefor is recorded, and particularly relates to a moving picture frame searching device, a moving picture frame searching method, and a record medium on which processing therefor is recorded regarding a moving picture stored in a random-accessible data storage.

2. Related Background Art

In recent years, a random-accessible data record medium such as a hard disk has been increasing in capacity. With this increase, even ordinary users come to store a bit stream in which a moving picture is converted into digital information on a hard disk.

When the bit stream of the moving picture is stored on the hard disk as described above, there sometimes occurs the necessity of searching for a moving picture frame which the user wishes to watch or moving picture frames in the neighborhood of that moving picture frame (hereinafter referred to as a neighborhood of a target frame) from within a successive bit stream.

In a device for searching for the neighborhood of the target frame which the user desires, in rough grouping, there are three ways of searching: (1) the utilization of high-speed reproduction; (2) the utilization of reproduction time information; and (3) the utilization of tag information incorporated in a video sequence.

(1) A method of searching the neighborhood of the target frame which the user desires by the use of high-speed reproduction (There are some cases where reproduction is performed at regular intervals) is, for example, as follows. First, a front position of a bit stream is located, and the bit stream is reproduced at a high speed on a monitor successively therefrom. The user keeps watch on the monitor during the high-speed reproduction, and stops the high-speed reproduction by using an input unit exactly when he or she confirms the desired neighborhood of the target frame on the monitor. Thus, the search for the neighborhood of the target frame which the user tries to watch is realized.

According to the aforementioned method, however, the bit stream of the moving picture is reproduced at a high speed, and hence there occurs the situation in which even if the high-speed reproduction is stopped when the user discovers the moving picture frame which he or she desires, the neighborhood of the target frame is passed long ago. Namely, there occurs a problem that timing in which the high-speed reproduction is stopped is severe. Moreover, even when the reproduction is performed at regular intervals, there is a problem that search takes a lot of time since the search is linear with respect to a time base.

(2) A method of searching for the neighborhood of the target frame which the user desires by the use of reproduction time information is, for example, as follows. First, a period of time from the front of the video sequence in which the moving picture frame the user tries to watch is reproduced is inputted by the input unit. Subsequently, the beginning of the bit stream is located based on the inputted period of time. Thus, the search for the neighborhood of the target frame which the user tries to watch is realized.

According to the aforementioned method, however, the user needs to memorize reproduction time information on the moving picture frame, which causes a problem that the accuracy of search depends on the accuracy of the user's memory.

(3) A method of searching for the neighborhood of the target frame which the user tries to watch by the use of tag information incorporated in the bit stream (Tag information is outside the bit stream in some cases) is, for example, as follows. First, a tag temporally closest to the moving picture frame which the user tries to watch is selected from a list of tag information incorporated in the video sequence and inputted by the input unit. Then, the beginning of the bit stream is located based on the selected tag. Thus, the search for the neighborhood of the target frame which the user tries to watch is realized.

According to the aforementioned method, however, there occurs a problem that it is necessary to previously incorporate tag information in moving picture frames.

As is clear from the above description, there is a problem that when the bit stream of the moving picture is stored on the hard disk or the like, various inconveniences occur in searching the moving picture frame which the user tries to watch.

### SUMMARY OF THE INVENTION

The present invention is made in view of the aforementioned problems, and an object of the present invention is to provide a moving picture frame searching method capable of searching for a target moving picture frame which the user tries to watch or its neighborhood with high accuracy.

In order to accomplish the aforementioned and other objects, according to one aspect of the present invention, a moving picture frame searching device, comprising:

a reproduction starting point fixing unit configured to divide a bit stream area of a moving picture stored in a data storage into a number n of bit stream subareas to fix reproduction starting points included in the bit stream subareas;

a picture reproducer configured to generate the number n of pictures by reading data out of each of the reproduction starting points and decoding the data, and multiplex and output the pictures; and

a selector configured to make a user select a bit stream subarea, in which a moving picture frame which the user tries to watch exists, among the bit stream subareas.

According to another aspect of the present invention, a picture processing device, comprising:

a picture reproducer to which bit streams concerning a number n of moving pictures are inputted, and which decodes the number n of bit streams to reproduce the number n of pictures; and

a multiplexer to which the number n of pictures are inputted, and which multiplexes and outputs these pictures.

According to a further aspect of the present invention, a method of searching for a moving picture frame, comprising:

a reproduction starting point fixing step of dividing a bit stream area of a moving picture stored in a data storage into a number n of bit stream subareas to fix reproduction starting points included in the bit stream subareas;

a picture reproducing step of generating the number n of pictures by reading data out of each of the reproduction starting points and decoding the data, and multiplexing and outputting the pictures; and

a selecting step of making a user select a bit stream subarea, in which a moving picture frame which the user tries to watch exists, among the bit stream subareas.

According to a still further aspect of the present invention, a record medium capable of being read by a computer, in which recorded is a program causing the computer to execute:

a reproduction starting point fixing step of dividing a bit stream area of a moving picture stored in a data storage into a number n of bit stream subareas to fix reproduction starting points included in the bit stream subareas;

a picture reproducing step of generating the number n of pictures by reading data out of each of the reproduction starting points and decoding the data, and multiplexing and outputting the pictures; and

a selecting step of making a user select a bit stream subarea, in which a moving picture frame which the user tries to watch exists, among the bit stream subareas.

### BRIEF DESCRIPTION OF THE DRAWINGS

FIG. 1 is a diagram showing a hardware configuration of a moving picture frame searching device according to a first embodiment of the present invention;

FIG. 2 is a diagram showing an example of a bit stream of a moving picture on which data are compressed by a MPEG;

FIG. 3 is a diagram showing an example of a bit stream stored in a hard disk unit;

FIG. 4 is a diagram showing pictures on a monitor in the first embodiment;

FIG. 5 is a diagram showing a hardware configuration of a moving picture frame searching device according to a second embodiment of the present invention;

FIG. 6 is a diagram showing pictures on the monitor in the second to fifth embodiments;

FIG. 7 is a diagram showing a hardware configuration of a moving picture frame searching device according to a third embodiment of the present invention;

FIG. 8 is a diagram showing a hardware configuration of a moving picture frame searching device according to a fourth embodiment of the present invention;

FIG. 8A is a diagram showing a modified example of the moving picture frame searching device according to the fourth embodiment;

FIG. 9 is a diagram showing a hardware configuration of a moving picture frame searching device according to a fifth embodiment of the present invention;

FIG. 9A is a diagram showing a modified example of the moving picture frame searching device according to the fifth embodiment;

FIG. 10 is a flowchart explaining processing by a moving picture frame searching device according to the first through the fifth embodiments of the present invention (a sixth embodiment); and

FIG. 11 is a diagram showing an example of a hardware configuration in the case where the present invention is realized by a personal computer (a seventh embodiment).

### DESCRIPTION OF THE PREFERRED EMBODIMENTS

An example of the present invention is designed to specify some area from a bit stream of a moving picture, fix a number n of bit stream subareas from within the aforementioned bit stream area, and simultaneously reproduce pictures existing in the respective bit stream subareas on a monitor divided into n parts. A user confirms reproduced pictures and selects a bit stream subarea in which a neighborhood of a target frame which he or she wants to watch exists out of the number n of bit stream subareas by means of an input unit. The example of the present invention allows the neighborhood of the target frame which the user wishes to watch to be searched more accurately by repeating this operation. More detailed explanation will be given below.

### [First Embodiment]

The first embodiment of the present invention is designed to select the neighborhood of a target moving picture frame which the user tries to watch by displaying static pictures at the front positions of or near the front positions of bit stream subareas obtained by dividing a bit stream into two parts.

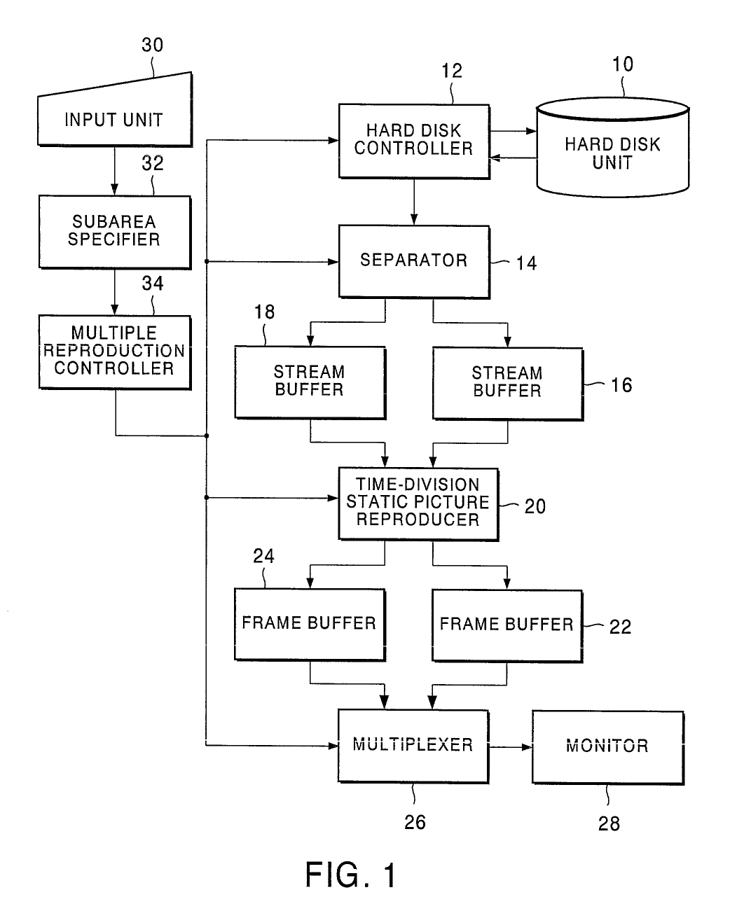

FIG. 1 is a diagram showing a hardware configuration of a moving picture frame searching device according to the first embodiment of the present invention. As shown in FIG. 1, the moving picture frame searching device according to this embodiment is configured to include a hard disk unit 10, a hard disk controller 12, a separator 14, stream buffers 16 and 18, a time-division static picture reproducer 20, frame buffers 22 and 24, a multiplexer 26, and a monitor 28, and further includes an input unit 30, a subarea specifier 32, and a multiple reproduction controller 34.

A bit stream to be searched is stored in the hard disk unit 10. In this embodiment, a bit stream in which MPEG (Moving Picture Experts Group) is used as a method of compressing the moving picture is stored in the hard disk 10. Incidentally, although the MPEG has some kinds such as MPEG2, MPEG4, and the like, the present invention is not limited to these kinds. These are generally referred to as the MPEG hereinafter. As examples of this bit stream of the moving picture, moving picture data obtained from television broadcasting, moving picture data obtained from Internet by the user, and the like are given.

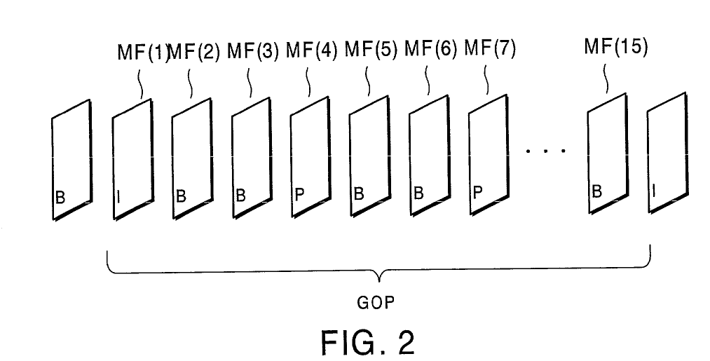

FIG. 2 is a diagram showing an example of a bit stream of the MPEG2 as an example of the MPEG. As shown in FIG. 2, one bit stream is composed of a plurality of GOPs (Group of Pictures), and one GOP includes 15 moving picture frames MF(1) to MF(15). In this embodiment, these 15 moving picture frames MF(1) to MF(15) are reproduced in a half of a second. In this embodiment, one GOP forms one block on data structure.

These moving picture frames MF(1) to MF(15) are classified into the moving picture frame MF(1) which is an I picture, the moving picture frames MF(4), MF(7) . . . which are P pictures, and the moving picture frames MF(2), MF(3), MF(5), MF(6) . . . MF(15) which are B pictures.

The I picture (Intra-Picture) is a frame in which all picture data on the moving picture frame MF(1) are intra-coded, and secures the independency of data on GOPs from one another. Therefore, it is possible to reproduce one moving picture frame by decoding compressed data on one moving picture frame MF(1).

The P picture (Predictive-Picture) is a moving picture frame capable of reproducing one picture by performing forward prediction between frames based on the closest previous I or P picture.

The B picture (Bidirectionally-Picture) is a moving picture frame capable of reproducing one picture by performing bidirectional prediction between frames based on the closest previous and succeeding I or P picture.

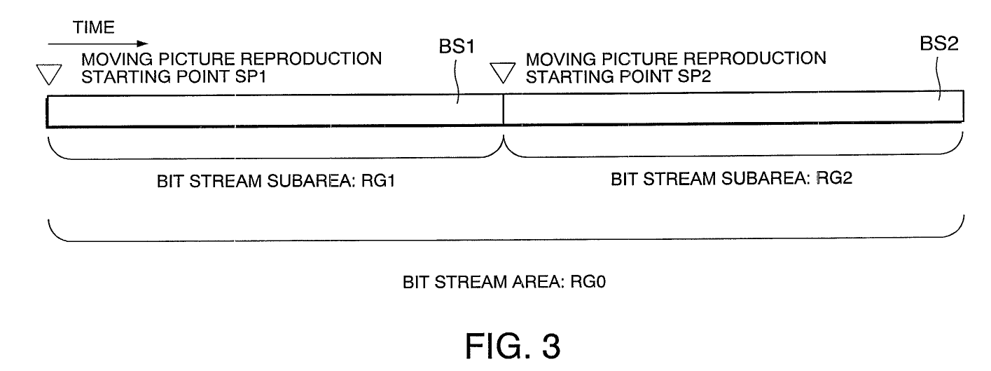

FIG. 3 is a diagram showing a bit stream area RG0 stored in the hard disk unit 10. Let this bit stream area RG0 be moving picture contents which the user tries to watch. The user specifies this bit stream area RG0 by means of the input unit 30. On this occasion, the user searches for the neighborhood of the target frame which he or she wishes to watch by the following process, where the neighborhood of the target frame means a moving picture frame group included in a GOP to which the moving picture frame which the user tries to watch belongs or GOPs which adjoin this GOP by previous and succeeding several frames.

(1) The moving picture frame searching device first divides the bit stream area RG0 into two bit stream subareas RG1 and RG2 by means of the subarea specifier 32. The subarea specifier 32 specifies two moving picture reproduction starting points SP1 and SP2 from within these bit stream subareas RG1 and RG2. In this embodiment, the moving picture reproduction starting point SP1 is set at the front position of the bit stream area RG0, and the moving picture reproduction starting point SP2 is set at an intermediate point of the bit stream area RG0. For explanation, the bit stream subarea RG1 is defined as an area in which the front position of the bit stream area RG0 is a starting point and in which a point immediately before the moving picture reproduction starting point SP2 is an end point. Moreover, the bit stream subarea RG2 is defined as an area in which the moving picture reproduction starting point SP2 is a starting point and in which the rear position of the bit stream area RG0 is an end point. The subarea specifier 32 transmits these two moving picture reproduction starting points SP1 and SP2 to the multiple reproduction controller 34. The multiple reproduction controller 34 controls the hard disk controller 12, the separator 14, the time-division static picture reproducer 20, and the multiplexer 26 based on this command.

(2) The moving picture frame searching device then reproduces I pictures at the front positions of the GOPs, which start from the moving picture reproduction starting points SP1 and SP2, as static pictures.

More specifically, the hard disk controller 12 reads data as a bit stream BS1 out of the bit stream subarea RG1 with the moving picture reproduction starting point SP1 stored in the hard disk unit 10 as its starting point, and reads data as a bit stream BS2 out of the bit stream subarea RG2 with the moving picture reproduction starting point SP2 as its starting point. These bit streams BS1 and BS2 are read out time-divisionally.

The bit streams BS1 and BS2 read out are identified and separated by the separator 14, and separately written in the stream buffers 16 and 18. Specifically, the bit stream BS1 is written in the stream buffer 16, and the bit stream BS2 is written in the stream buffer 18.

The time-division static picture reproducer 20 reads the bit streams BS1 and BS2 out of the stream buffers 16 and 18, and performs the following two operations time-divisionally. Namely, the time-division static picture reproducer 20 searches for an initial GOP header of the bit stream BS1 and then decodes only an I picture IP1 at the front position of the GOP. The decoded I picture IP1 is stored in the frame buffer 22. Also, it searches for an initial GOP header of the bit stream BS2 and then decodes only an I picture IP2 at the front position of the GOP. The decoded I picture IP2 is stored in the frame buffer 24. Namely, the time-division static picture reproducer 20 functions as an MPEG decoder.

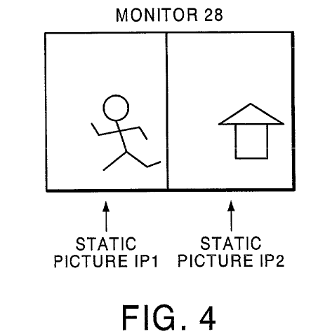

The multiplexer 26 reads data on the I pictures IP1 and IP2 stored in the frame buffers 22 and 24 as static pictures, and displays them simultaneously on the monitor 28. In other words, the multiplexer 26 reduces and multiplexes the static pictures of the I pictures IP1 and IP2, and outputs the multiplexed I pictures IP1 and IP2 to the monitor 28. FIG. 4 is a diagram showing an example of a state in which the I pictures IP1 and IP2 as static pictures are displayed on the monitor 28.

(3) The user determines which of the bit stream subareas RG1 and RG2 has the desired neighborhood of the target frame by watching the reproduced static pictures (I pictures IP1 and IP2) on the monitor 28. The user selects one static picture out of two static pictures (I pictures IP1 and IP2), on the side of which the user has determined that the target moving picture frame he or she wishes to watch exists. Specifically, the user selects the corresponding static picture (the I picture IP1 or IP2) by the use of the input unit 30. When the user selects the I picture IP1, for example, the bit stream subarea RG1 is specified by this selection, and this bit stream subarea RG1 is divided into two parts by the same processing as the aforementioned processing is performed in the next operation. When the user determines that the desired neighborhood of the target frame extends over both of the bit stream subareas RG1 and RG2, either of the bit stream subareas can be specified.

By repeatedly performing the aforementioned operations (1), (2) and (3), the neighborhood of the target frame which the user tries to watch comes to be situated at the moving picture reproduction starting point SP1 or SP2, whereby the neighborhood of the target frame can be searched, and thereafter the bit stream can be reproduced from that position.

As described above, according to the moving picture frame searching device in accordance with this embodiment, in search, the user determines after which of the two static pictures the neighborhood of the target frame is situated by watching the static pictures displayed on the monitor 28, and may determine which one is closer to the neighborhood of the target frame. Therefore, there is an advantage that input is easier compared with the case where high-speed reproduction is used in search. Namely, restriction on timing in which the input unit 30 inputs the selection of the user is eliminated, thereby creating an advantage that search is facilitated.

Moreover, according to this embodiment, hierarchical search can be performed with respect to a time base, whereby the neighborhood of the target frame can be located in a short time. Further, it becomes possible to search for the neighborhood of the target frame with sufficient accuracy. Furthermore, it becomes unnecessary to previously incorporate the tag information in the bit stream.

### [Second Embodiment]

In the second embodiment of the present invention, the static pictures reproduced on the monitor in the first embodiment are changed into moving pictures.

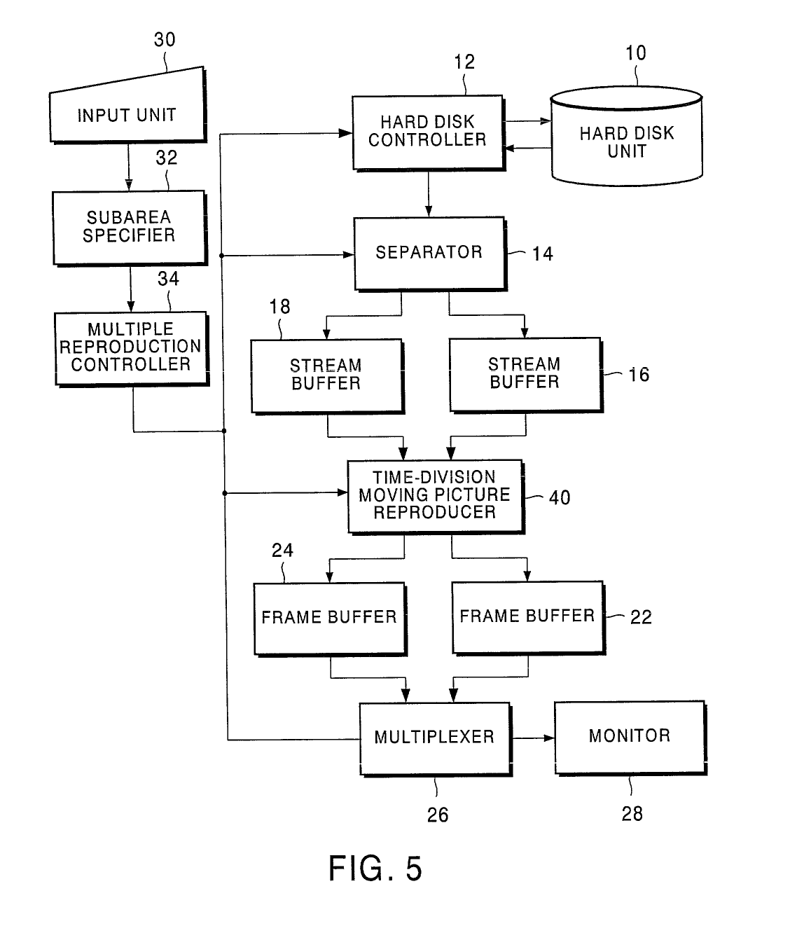

FIG. 5 is a diagram showing a hardware configuration of a moving picture frame searching device according to the second embodiment of the present invention. As shown in FIG. 5, the moving picture frame searching device according to the second embodiment includes a time-division moving picture reproducer 40 in place of the aforementioned time-division static picture reproducer 20 in the first embodiment.

The time-division moving picture reproducer 40 reads the bit streams BS1 and BS2 sequentially out of the stream buffers 16 and 18, and performs the following two operations time-divisionally. Namely, the time-division moving picture reproducer 40 searches for the initial GOP header of the bit stream BS1 and decodes a moving picture VI1 therefrom. The decoded moving picture VI1 is stored in the frame buffer 22. Also, it searches for the initial GOP header of the bit stream BS2 and decodes a moving picture VI2 therefrom. The decoded moving picture VI2 is stored in the frame buffer 24. Namely, the time-division moving picture reproducer 40 functions as an MPEG decoder.

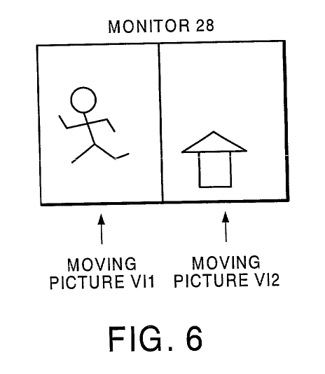

The multiplexer 26 reads data on the moving pictures VI1 and VI2 stored in the frame buffers 22 and 24, and simultaneously outputs them to the monitor 28. In other words, the multiplexer 26 reduces and multiplexes the moving pictures VI1 and VI2, and outputs the multiplexed moving pictures VI1 and VI2 to the monitor 28. FIG. 6 is a diagram showing an example of a state in which the moving pictures VI1 and VI2 are displayed on the monitor 28.

The user determines in which of the bit stream subareas RG1 and RG2 the desired neighborhood of the target frame exists by watching the moving pictures VI1 and VI2 reproduced on the monitor 28. The user selects one moving picture out of the two moving pictures VI1 and VI2, on the side of which the user has determined that the target moving picture frame he or she wishes to watch exists. Specifically, the user selects the corresponding moving picture VI1 or VI2 by the use of the input unit 30. When the user selects the moving picture VI1, for example, the bit stream subarea RG1 is specified by this selection, and this bit stream subarea RG1 is divided into two parts this time by the same processing as the aforementioned processing is performed in the next operation. When the user determines that the desired neighborhood of the target frame extends over both of the bit stream subareas RG1 and RG2, either of the bit stream subareas can be specified.

By repeatedly performing the aforementioned operations, the neighborhood of the target frame which the user tries to watch comes to be situated at the moving picture reproduction starting point SP1 or SP2, whereby the neighborhood of the target frame can be searched, and thereafter the bit stream can be reproduced from that position.

Moreover, the multiple reproduction controller 34 performs control necessary to continuously display the moving pictures VI1 and VI2 on the monitor 28 as described above.

As described above, according to the moving picture frame searching device in accordance with this embodiment, on the occasion of search, the user determines after which of the two moving pictures VI1 and VI2 the neighborhood of the target frame is situated by watching the moving pictures VI1 and VI2 displayed on the monitor 28, and can determine which one is closer to the neighborhood of the target frame. Therefore, there is an advantage that input is easier compared with the case where high-speed reproduction is used in search. Namely, restriction on timing in which the input unit 30 inputs the user's selection is eliminated, thereby creating an advantage that search is facilitated.

Moreover, according to this embodiment, hierarchical search can be performed with respect to a time base, whereby the neighborhood of the target frame can be located in a short time. Further, it becomes possible to search for the neighborhood of the target frame with sufficient accuracy. Furthermore, it becomes unnecessary to previously incorporate tag information in the bit stream.

### [Third Embodiment]

In the third embodiment of the present invention, the aforementioned moving picture frame searching device according to the second embodiment is modified and provided with moving picture reproducers respectively in two bit streams.

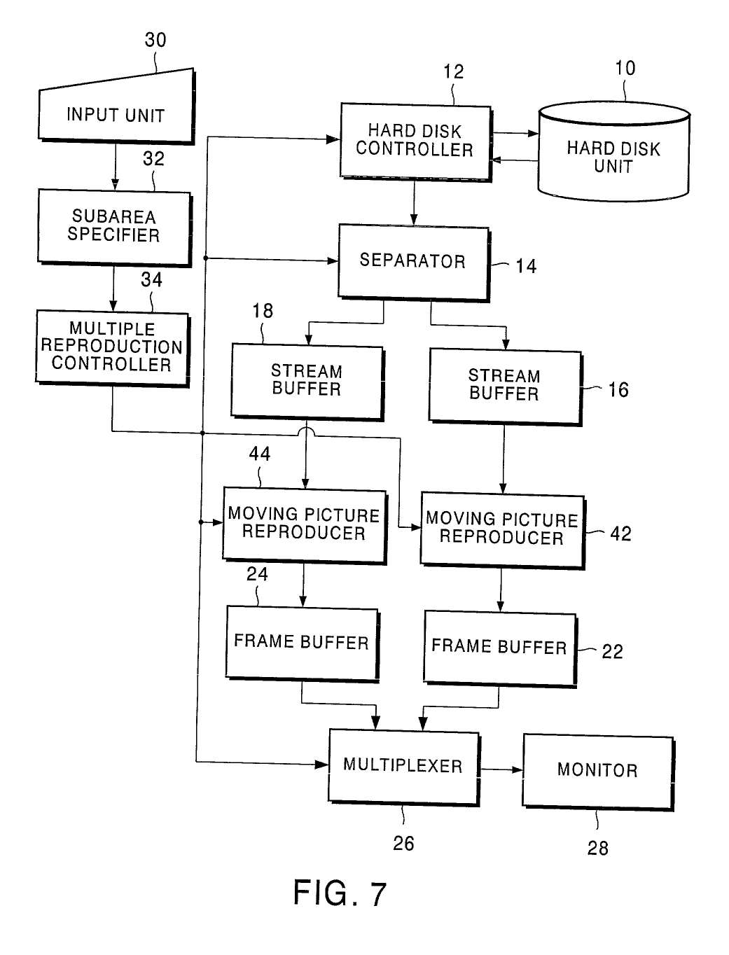

FIG. 7 is a diagram showing a hardware configuration of a moving picture frame searching device according to the third embodiment of the present invention. As shown in FIG. 7, the moving picture frame searching device includes moving picture reproducers 42 and 44 in place of the time-division moving picture reproducer 40.

The moving picture reproducer 42 reads the bit stream BS1 sequentially out of the stream buffer 16, subsequently searches for the initial GOP header of the bit stream BS1, and decodes the moving picture VI1 therefrom. The decoded moving picture VI1 is stored in the frame buffer 22. Also, the moving picture reproducer 44 reads the bit stream BS2 sequentially out of the stream buffer 18, subsequently searches for the initial GOP header of the bit stream BS2, and decodes the moving picture VI2 therefrom. The decoded moving picture VI2 is stored in the frame buffer 24. Namely, the moving picture reproducers 42 and 44 each function as an MPEG decoder.

Similarly to the aforementioned second embodiment, the multiplexer 26 reads data on the moving pictures VI1 and VI2 stored in the frame buffers 22 and 24, and simultaneously outputs them to the monitor 28 as shown in FIG. 6. The user determines in which of the bit stream subareas RG1 and RG2 the desired neighborhood of the target frame exists by watching the moving pictures VI1 and VI2 reproduced on the monitor 28.

As described above, the moving picture frame searching device according to this embodiment is provided with the two moving picture reproducers 42 and 44. Hence, it becomes unnecessary to use the moving picture reproducers 42 and 44 time-divisionally, whereby the device can cope with a case where the processing performance of the moving picture reproducers 42 and 44 are not so high.

### [Fourth Embodiment]

In the fourth embodiment of the present invention, only the I and P pictures are reproduced in the time-division moving picture reproducer in the second embodiment.

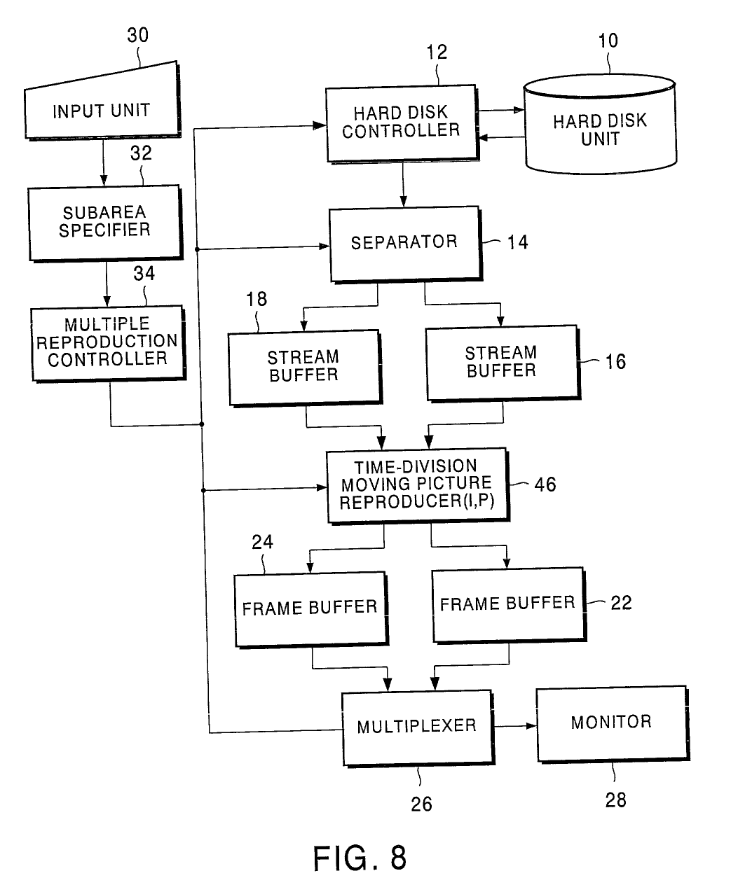

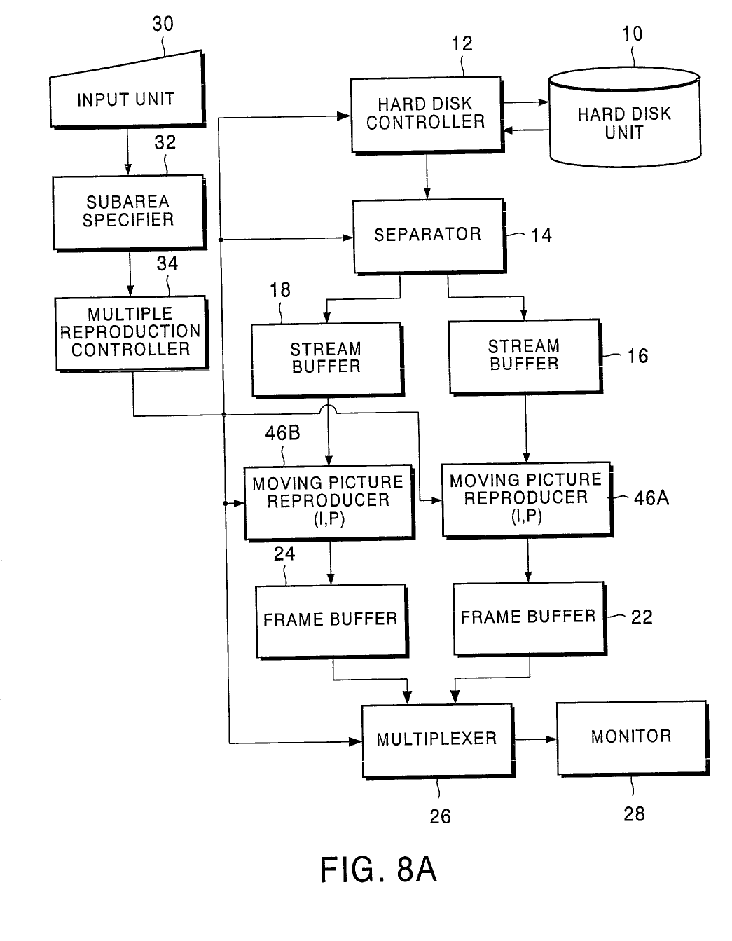

FIG. 8 is a diagram showing a hardware configuration of a moving picture frame searching device according to the fourth embodiment of the present invention. As shown in FIG. 8, in this embodiment, the device includes a time-division moving picture reproducer 46 which selects and reproduces only the I and P pictures.

This time-division moving picture reproducer 46 sequentially reads the bit streams BS1 and B2 out of the stream buffers 16 and 18 and performs the following two operations time-divisionally and sequentially. Specifically, the time-division moving picture reproducer 46 searches for the initial GOP header of the bit stream BS1, and searches for and decodes only the I and P pictures sequentially therefrom. The decoded picture is taken as the moving picture VI1. The decoded moving picture VI1 is stored in the frame buffer 22. Also, the time-division moving picture reproducer 46 searches for the initial GOP header of the bit stream BS2, and searches for and decodes only the I and P pictures sequentially therefrom. The decoded picture is taken as the moving picture VI2. The decoded moving picture VI2 is stored in the frame buffer 24. Namely, the time-division moving picture reproducers 46 functions as an MPEG decoder.

Similarly to the aforementioned second embodiment, the multiplexer 26 reads data on the moving pictures VI1 and VI2 stored in the frame buffers 22 and 24, and simultaneously outputs them to the monitor 28 as shown in FIG. 6. The user determines in which of the bit stream subareas RG1 and RG2 the desired neighborhood of the target frame exists by watching the moving pictures VI1 and VI2 reproduced on the monitor 28.

As described above, the moving picture frame searching device according to this embodiment is designed to sequentially reproduce only the I pictures and P pictures out of the bit stream. Hence, reproduction is easier compared with the second embodiment, whereby the device can cope with a case where the processing speeds of the time-division moving picture reproducer 46 is not so fast.

Moreover, as shown in FIG. 8A, the moving picture frame searching device may include two moving picture reproducers 46A and 46B, each of which sequentially reproduces only the I pictures and P pictures out of the bit stream, in place of the time-division moving picture reproducer 46. Hence, it becomes unnecessary to use the moving picture reproducers 46A and 46B time-divisionally, whereby the device can cope with a case where the processing performance of the moving picture reproducers 46A and 46B are not so high.

### [Fifth Embodiment]

In the fifth embodiment of the present invention, only the I pictures is reproduced in the time-division moving picture reproducer in the second embodiment.

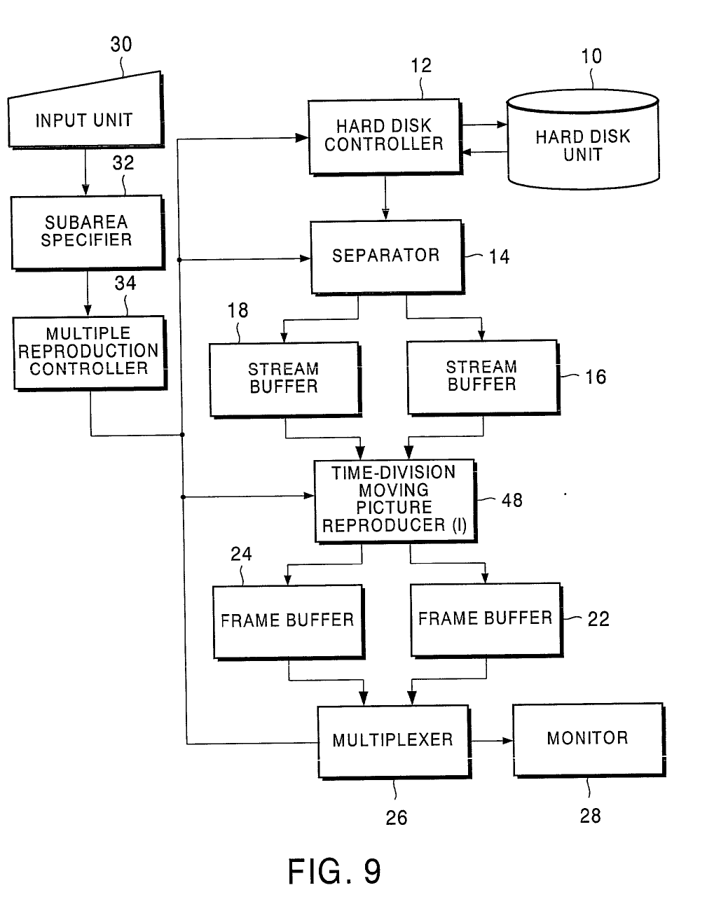

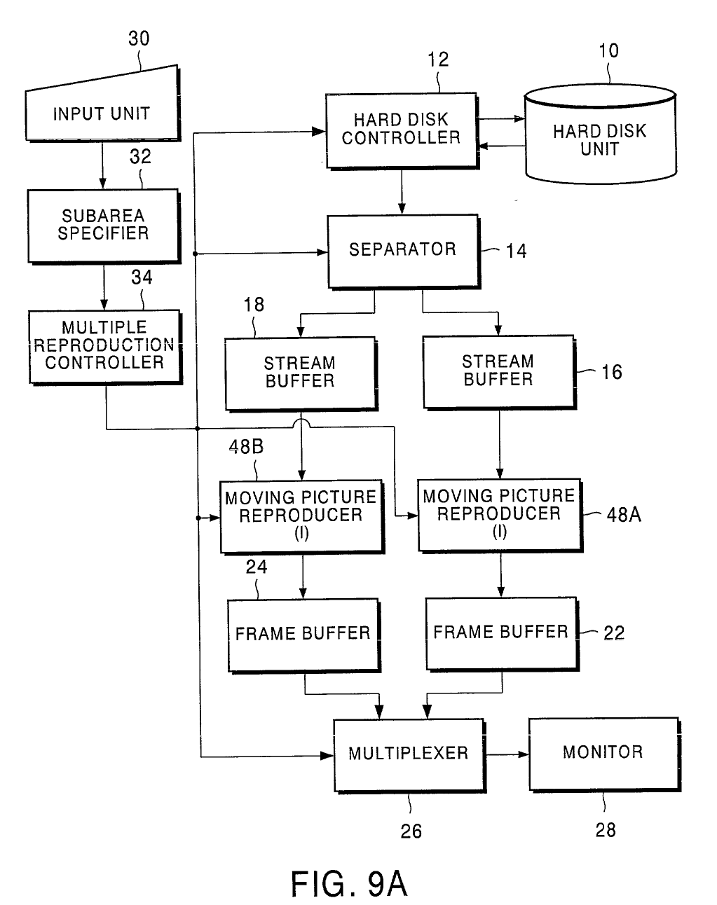

FIG. 9 is a diagram showing a hardware configuration of a moving picture frame searching device according to the fifth embodiment of the present invention. As shown in FIG. 9, in this embodiment, the device includes a time-division moving picture reproducer 48 which selects and reproduces the I pictures only.

This time-division moving picture reproducer 48 reads the bit streams BS1 and B2 out of the stream buffers 16 and 18 and performs the following two operations time-divisionally and sequentially. Specifically, the time-division moving picture reproducer 48 searches for the initial GOP header of the bit stream BS1, and searches for and decodes only the I picture sequentially therefrom. The decoded picture is taken as the moving picture VI1. The decoded moving picture VI1 is stored in the frame buffer 22. Also, the time-division moving picture reproducer 48 searches for the initial GOP header of the bit stream BS2, and searches for and decodes only the I picture sequentially therefrom. The decoded picture is taken as the moving picture VI2. The decoded moving picture VI2 is stored in the frame buffer 24. Namely, the time-division moving picture reproducers 48 functions as an MPEG decoder.

Similarly to the aforementioned second and fourth embodiments, the multiplexer 26 reads data on the moving pictures VI1 and VI2 stored in the frame buffers 22 and 24, and simultaneously outputs them to the monitor 28 as shown in FIG. 6. The user determines in which of the bit stream subareas RG1 and RG2 the desired neighborhood of the target frame exists by watching the moving pictures VI1 and VI2 reproduced on the monitor 28.

As described above, the moving picture frame searching device according to this embodiment is designed to sequentially reproduce only the I pictures from within the bit stream. Hence, reproduction is easier compared with the fourth embodiment, whereby the device can cope with a case where the processing performance of the time-division moving picture reproducer 48 is not so high.

Moreover, as shown in FIG. 9A, the moving picture frame searching device may include two moving picture reproducers 48A and 48B, each of which sequentially reproduces only the I pictures out of the bit stream, in place of the time-division moving picture reproducer 48. Hence, it becomes unnecessary to use the moving picture reproducers 48A and 48B time-divisionally, whereby the device can cope with a case where the processing performance of the moving picture reproducers 48A and 48B are not so high.

### [Sixth Embodiment]

In the sixth embodiment, the processing of searching for the moving picture frame in the aforementioned first to fifth embodiments will be explained by means of a flowchart.

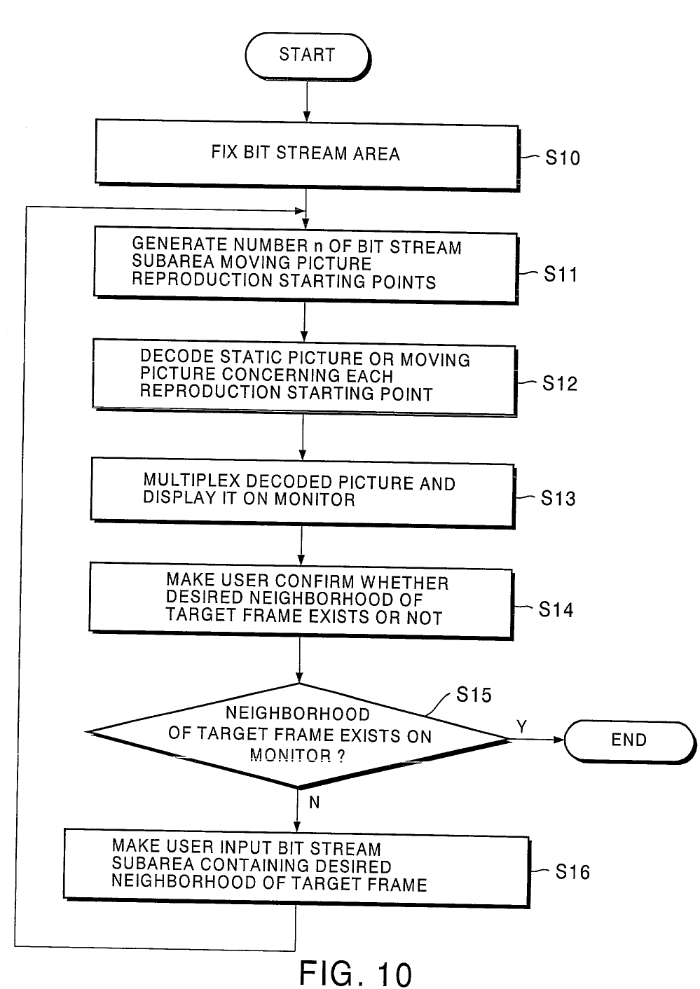

FIG. 10 is a flowchart of the processing of searching for the moving picture frame in the aforementioned first to fifth embodiments. As shown in FIG. 10, the moving picture frame searching device first fixes the bit stream area RG0 in the hard disk unit 10 (step S10). Subsequently, the moving picture reproduction starting points SP1 and SP2 in the two (n=2 in the aforementioned embodiments) of bit stream subareas RG1 and RG2 are generated (step S11).

Next, the moving picture frame searching device decodes the static pictures IP1 and IP2 or the moving pictures VI1 and VI2 with respect to the respective moving picture reproduction starting points SP1 and SP2 (step S12), and then multiplexes the static pictures IP1 and IP2 or the moving pictures VI1 and VI2 and displays them on the monitor 28.

Thereafter, the user confirms whether the neighborhood of the target frame which he or she tries to watch exists on the monitor 28 (step S14). When the neighborhood of the target frame exists on the monitor 28 (step S15: Yes), this processing for search is completed. Meanwhile, when the neighborhood of the target frame does not exist on the monitor 28 (step S15: No), the user selects one in which the neighborhood of the target frame exists out of the bit stream subarea RG1 or RG2 based on the display on the monitor (step S16). The aforementioned processing from step S11 is repeated with the selected bit stream subarea as a new bit stream area.

### [Seventh Embodiment]

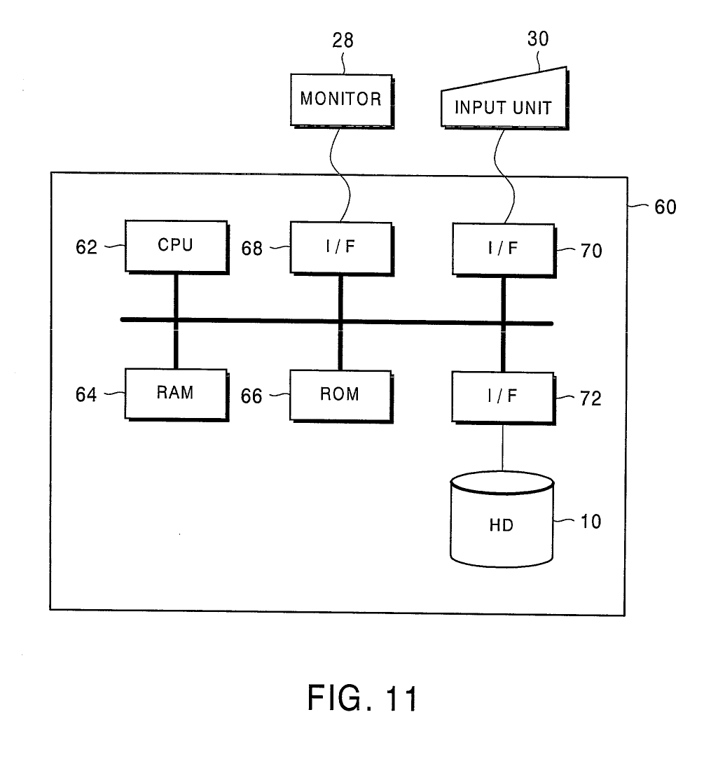

In the seventh embodiment of the present invention, the moving picture frame searching device according to the aforementioned first to fifth embodiments is realized by a personal computer. FIG. 11 is a diagram showing a hardware configuration thereof.

As shown in FIG. 11, the seventh embodiment is configured to include a personal computer main frame 60, the monitor 28, and the input unit 30. In the personal computer main frame 60, a CPU 62, a RAM 64, a ROM 66, and interfaces 68, 70, and 72 are connected to each other via an internal bus.

The monitor 28 is connected to the interface 68. The input unit 30 is connected to the interface 70. In this embodiment, the input unit 30 is composed of a key board. The hard disk unit 10 is connected to the interface 72.

In this embodiment, for example, the RAM 64 functions as the aforementioned stream buffers 16 and 18, and frame buffers 22 and 24, and the CPU 62 functions as the aforementioned subarea specifier 32, multiple reproduction controller 34, hard disk controller 12, separator 14, time-division static picture reproducer 20, time-division moving picture reproducers 40, 46, and 48, moving picture reproducers 42 and 44, and the multiplexer 26.

A program for making the CPU 62 fulfill the functions of these processing units is stored in the hard disk unit 10 or the ROM 66. The readout and execution of this program by the CPU 62 can realize the aforementioned respective embodiments.

As shown in this embodiment, the present invention can be easily realized also by a system which uses the personal computer.

It should be mentioned that the present invention is not limited to the aforementioned embodiments and can be modified variously. For example, in the aforementioned embodiments, the monitor 28 is divided into two parts and the static pictures IP1 and IP2 or the moving pictures VI1 and VI2 are displayed, but the monitor 28 may be divided into four parts, nine parts, or the like, and the pictures may be displayed on the monitor 28. In these case, the bit stream area RG0 is divided into four parts or nine parts to generate bit stream subareas RG1 to RG4 or RG1 to RG9.

Although the aforementioned moving picture starting point SP2 is set at a point indicating a half of the data length of the bit stream area RG0, it is not limited to this. For example, when time information is incorporated into the bit stream area RG0, a point indicating a half of the total reproduction time may be set as the moving picture reproduction starting point SP2 based on this time information.

Moreover, it is possible to integrate the plurality of units in each of the aforementioned embodiments into one integrated circuit (IC). In the first embodiment, for example, the subarea specifier 32, the multiple reproduction controller 34, the time-division static picture reproducer 20, and the multiplexer 26 can be realized as one IC.

As for each processing explained in the aforementioned embodiments, it is possible to record a program for executing the processing on a record medium such as a floppy disk, a CD-ROM (Compact Disc-Read Only Memory), a ROM, a memory card and distribute it in the form of the record medium. In this case, the aforementioned embodiments can be realized by the readout and execution of the record medium, in which this program is recorded, by the personal computer main frame 60.

The personal computer main frame 60 sometimes has other programs such as an operating system, different application programs, and the like, in which case it is suitable to utilize other programs which the personal computer main frame 60 has and to record a command capable of calling a program for realizing processing equivalent to that in this embodiment out of the programs possessed by the personal computer main frame 60 on a the record medium.

Further, such a program can be distributed not in the form of a record medium but in the form of a carrier wave via a network. The program transmitted in the form of the carrier wave over the network is incorporated in the personal computer main frame 60, and the aforementioned embodiments can be realized by executing this program.

Furthermore, when being recorded in the record medium or transmitted as the carrier wave over the network, the program is sometimes encoded or compressed. In this case, the personal computer main frame 60 which has read the program out of the record medium or the carrier wave needs to execute the program after decoding or expanding it.

What is claimed is:

1. A moving picture frame searching device, comprising:
a reproduction starting point fixing unit configured to divide a bit stream area of a moving picture stored in a data storage into a number n of bit stream subareas to fix reproduction starting points included in the bit stream subareas;
a picture reproducer configured to generate the number n of pictures by reading data out of each of the reproduction starting points and decoding the data, and multiplex and output the pictures; and
a selector configured to make a user select a bit stream subarea, in which a moving picture frame which the user tries to watch exists, among the bit stream subareas.

2. The moving picture frame searching device according to claim 1, wherein the bit stream is composed of a plurality of blocks,
wherein each of the blocks comprises three kinds of data which are a first picture data, a second picture data, and a third picture data,
wherein the first picture data are data in which all data on one picture are encoded,
the second picture data are data capable of decoding data on one picture by referring to the nearest previous first picture data or second picture data, and
the third picture data are data capable of decoding data on one picture by referring to the nearest previous first picture data or second picture data and the nearest succeeding first picture data or second picture data.

3. The moving picture frame searching device according to claim 1, wherein the picture reproducer reproduces and outputs a static picture.

4. The moving picture frame searching device according to claim 2, wherein the picture reproducer decodes the first picture data at a front position of the bit stream subarea.

5. The moving picture frame searching device according to claim 1, wherein the picture reproducer reproduces and outputs a moving picture.

6. The moving picture frame searching device according to claim 2, wherein the picture reproducer decodes the first picture data, the second picture data and the third picture data in each of the blocks from the block at the front position of the bit stream subarea in order.

7. The moving picture frame searching device according to claim 6, wherein the picture reproducer time-divisionally decodes data out of the number n of the bit stream subareas.

8. The moving picture frame searching device according to claim 6, wherein the picture reproducer comprises the number n of moving picture reproducers, each of which independently decodes data out of the number n of the bit stream subareas.

9. The moving picture frame searching device according to claim 2, wherein the picture reproducer decodes only the first and second picture data in each of the blocks from the block at the front position of the bit stream subarea in order.

10. The moving picture frame searching device according to claim 9, wherein the picture reproducer time-divisionally decodes data out of the number n of the bit stream subareas.

11. The moving picture frame searching device according to claim 9, wherein the picture reproducer comprises the number n of moving picture reproducers, each of which independently decodes data out of the number n of the bit stream subareas.

12. The moving picture frame searching device according to claim 2, wherein the picture reproducer decodes only the first picture data in each of the blocks from the block at the front position of the bit stream subarea in order.

13. The moving picture frame searching device according to claim 12, wherein the picture reproducer time-divisionally decodes data out of the number n of the bit stream subareas.

14. The moving picture frame searching device according to claim 12, wherein the picture reproducer comprises the number n of moving picture reproducers, each of which independently decodes data out of the number n of the bit stream subareas.

15. A picture processing device, comprising:
a picture reproducer to which bit streams concerning a number n of moving pictures are inputted, and which decodes the number n of bit streams to reproduce the number n of pictures; and
a multiplexer to which the number n of pictures are inputted, and which multiplexes and outputs these pictures.

16. The picture processing device according to claim 15, wherein the picture reproducer time-divisionally decodes data of the number n of the bit stream.

17. The picture processing device according to claim 16, wherein the picture reproducer comprises the number n of moving picture reproducers, each of which independently decodes data of the number n of the bit stream.

18. A method of searching for a moving picture frame, comprising:
a reproduction starting point fixing step of dividing a bit stream area of a moving picture stored in a data storage into a number n of bit stream subareas to fix reproduction starting points included in the bit stream subareas;
a picture reproducing step of generating the number n of pictures by reading data out of each of the reproduction starting points and decoding the data, and multiplexing and outputting the pictures; and
a selecting step of making a user select a bit stream subarea, in which a moving picture frame which the user tries to watch exists, among the bit stream subareas.

19. A record medium capable of being read by a computer, in which recorded is a program causing the computer to execute:
a reproduction starting point fixing step of dividing a bit stream area of a moving picture stored in a data storage into a number n of bit stream subareas to fix reproduction starting points included in the bit stream subareas;
a picture reproducing step of generating the number n of pictures by reading data out of each of the reproduction starting points and decoding the data, and multiplexing and outputting the pictures; and
a selecting step of making a user select a bit stream subarea, in which a moving picture frame which the user tries to watch exists, among the bit stream subareas.
